(19) United States
(12) Patent Application Publication
(10) Pub. No.: US 2010/0255878 A1
(43) Pub. Date: Oct. 7, 2010

(54) AUDIO FILTER

(76) Inventors: Alan Amron, Woodbury, NY (US); Eric T. Brewer, Palo Alto, CA (US)

Correspondence Address: OSTROLENK FABER GERB & SOFFEN, 1180 AVENUE OF THE AMERICAS, NEW YORK, NY, 100368403, US

(21) Appl. No.: 12/753,828

(22) Filed: Apr. 2, 2010

Related U.S. Application Data
(60) Provisional application No. 61/166,153, filed on Apr. 2, 2009.

(51) Int. Cl. H04B 1/38; H04R 3/02

(52) U.S. Cl. 455/557; 381/73.1

(57) ABSTRACT

An audio filter in accordance with an embodiment of the present application identifies and isolates a desired sound signal. The audio filter is preferably used in a telephone such as a wireless or cellular telephone and utilizes a position of a sound source to identify a desired sound source and thereafter filters out all other sound sources other than the desired sound source regardless of the position of the desired sound source.

### CROSS-REFERENCE TO RELATED APPLICATIONS

The present application claims benefit of and priority to U.S. Provisional Patent Application Ser. No. 61/166,153 entitled AUDIO FILTER filed Apr. 2, 2009, the entire contents of which are hereby incorporated by reference herein.

### BACKGROUND

1. Field of the Disclosure

The present disclosure relates to an audio filter that identifies and isolates a desired sound signal. In particular, the audio filter is preferably used in a telephone such as a wireless or cellular telephone and utilizes a position of a sound source to identify a desired sound source and thereafter filters out all other sound sources other than the desired sound source regardless of the position of the desired sound source.

2. Related Art

Wireless telephones, such as cellular telephones, have become an almost necessary accessory for most people in today's world. Despite the vast improvements in cellular telephone technology, however, it is often difficult to hear a caller, especially when he or she is in an environment with a lot of background noise. While some phones attempt to mask these background noises, the results are unreliable and choppy, which makes it even harder to understand the caller.

Accordingly, it would be desirable to provide an audio filter that avoids the problems noted above.

### SUMMARY

It is an object of the present invention to provide an audio filter that identifies a desired sound signal based on a position of a desired sound source and thereafter filters out all sound signals other than the desired sound signal regardless of position of the desired sound source.

An audio filter in accordance with an embodiment of the present application preferably includes a sound sensor operable to detect sound and to provide a sensor signal representative of sound detected by the sound sensor and a controller operable to process the sensor signal to provide a desired sound signal representative of sound from a desired sound source. The desired sound source is identified by a position of the desired sound source relative to the audio filter and the controller filters the sensor signal to isolate the desired sound signal even after the desired sound source has changed position.

A wireless telephone in accordance with an embodiment of the present application includes a sound sensor operable to detect sound and to provide a sensor signal representative of sound detected by the sound sensor, a controller operable to process the sensor signal to provide a desired sound signal representative of sound from a desired sound source, wherein the desired sound source is identified by a position of the desired sound source relative to the wireless telephone and the controller filters the sensor signal to isolate the desired sound signal even after the desired sound source has changed position, and an input/output device operable to wirelessly transmit the desired sound signal to another wireless telephone.

Other features and advantages of the present invention will become apparent from the following description of the invention which refers to the accompanying drawings.

### BRIEF DESCRIPTION OF THE DRAWINGS

FIG. 1 is a graphical illustration of a desired filtering result in which a complex sound signal is filtered to provide a single desired sound signal;

FIG. 2 is an exemplary block diagram of an audio filter in accordance with an embodiment of the present application;

FIG. 3 is an exemplary block diagram of a wireless telephone including the audio filter of the present application;

FIG. 4 is an exemplary block diagram of a controller used in the audio filter of FIG. 3;

FIG. 5 is an exemplary schematic of an audio filter in accordance with an embodiment of the present application;

FIG. 6 illustrates multiple sound sources and their position relative to the sound sensing devices of the audio filter of FIG. 5;

FIG. 7A illustrates a chart indicating the calculated distance between each of the sound sensing devices and each of the sound sources of FIG. 5;

FIG. 7B is a chart illustrating the calculated travel time of sound from each of the sound sources to each of the sound sensing devices of FIG. 5; and

FIG. 7C illustrates the phase delay in time between the second sound sensing device and the first sound sensing device with respect to sound from each of the sound sources in FIG. 5.

### DETAILED DESCRIPTION OF THE EMBODIMENTS

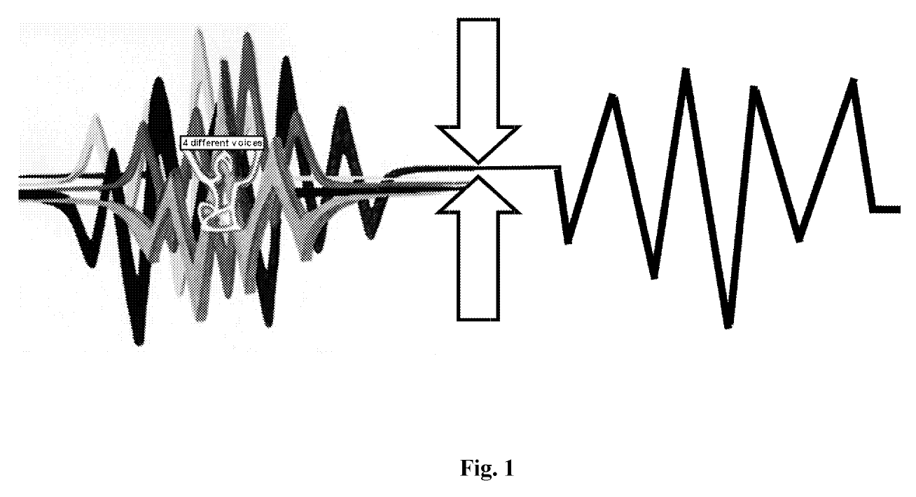

As is illustrated in the graphic of FIG. 1, when a caller is in a noisy environment, a plurality of sound signals related to the various sound sources, including people speaking and other background noise result in a complex sound signal that includes components of sound from all of the sources. This complex sound signal is illustrated graphically on the left side of FIG. 1. Filtering preferably results in isolation of a single desired sound signal, illustrated graphically on the right side of FIG. 1. However, as is noted above, currently existing filters often fail to isolate a single desired sound cleanly, thus resulting in garbled output that is difficult to understand.

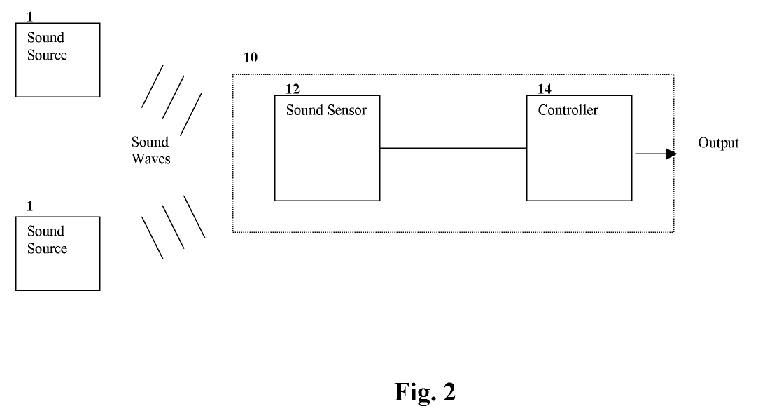

An audio filter 10 in accordance with an embodiment of the present disclosure is preferably used in a wireless telephone, such as a cellular telephone, and is illustrated generally in the block diagram of FIG. 2. It is within the scope of the present invention for the audio filter to be used in any kind of telephone that can benefit from the present invention. The audio filter 10 preferably includes at least one sound sensor 12 and a controller 14. The sound sensor 12 senses, or detects, sounds, for example, the sound waves produced by the sound sources 1 in FIG. 1 and provides an electronic output signal, or signals, representative of the sounds detected by the sound sensor. The controller 14 receives the output signal of the sound sensor 12 and processes it to filter out all elements that represent sounds other than a specific desired sound. The output of the controller 14, thus reflects only the desired sound signal.

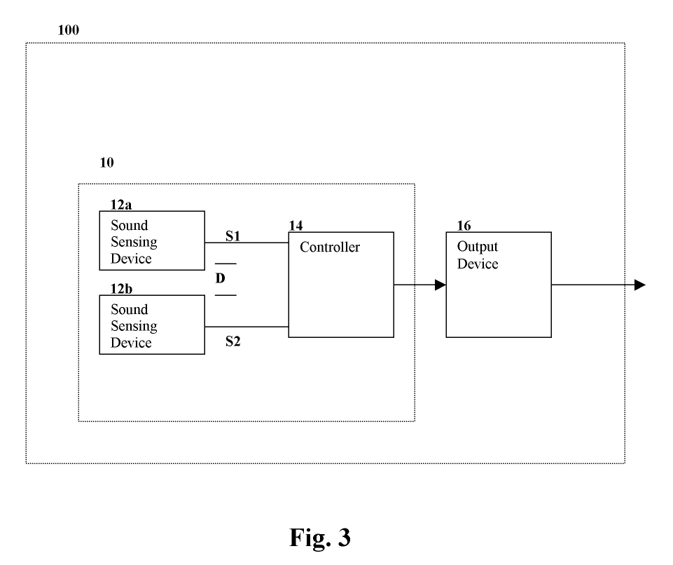

As can be seen in FIG. 3, the audio filter 10 is preferably provided in a wireless telephone 100. In a preferred embodiment, the output from the controller 14 is provided to an output device 16. While the device 16 is referred to as an output device, it may be both an input and output device if desired. From the output device 16, the desired sound signal preferably exits the wireless telephone 100. In one embodiment, the output device 16 is a transmitter-receiver device, or transceiver, that is operable to transmit and receive information, including the desired sound signal, to or from the wireless telephone 100. For this purpose, the transmitter-receiver may include a coding/decoding device (codec) to encode data prior to transmission as is common in wireless communications. Further, it is common for the information to be multiplexed prior to transmission. Thus, the transmitter-receiver 16 may also include a multiplexer and demultiplexer. Alternatively the codec, multiplexer and demulitplexer may be provided as stand alone devices or incorporated into the controller 14. The output device 16 may be a speaker, as well.

In a preferred embodiment, as illustrated in FIG. 3, for example, the sound sensor 12 preferably includes at least two sound sensing devices 12a, 12b. While two sound sensing devices 12a, 12b are illustrated in FIG. 3, it is noted that additional sound sensing devices may be used if desired, such as three, four or as many sound sensing devices as may be desired. These sound sensing devices 12a, 12b are positioned a predetermined distance (D) away from each other and in a known relationship with respect to each other. Since the sound sensing devices 12a, 12b are separated by a known distance D, the sound waves that they detect reach them at slightly different times. Thus, the slight phase difference between the output signals S1, S2 provided from the devices 12a, 12b to the controller 14 can be used to determine the relative position of each sound source relative to the wireless telephone 100. The sound sensing devices 12a, 12b may simply be microphones, if desired, however any device that converts the compression waves of sound into a representative electronic signal may be used. The position of each sound source is determined based on the phase shift utilizing one of a variety of known methods. One, non-limiting example of such a method is discussed below in further detail.

At least two sound sensing devises are utilized in the preferred embodiment to create the phase difference discussed above. Using more than two sound sensing devices, e.g., three of four, will allow for the determination of a more precise position for each of the sound sources relative to the sound sensing devices. Using four or more sound sensing devices will allow for a unique position of each sound source within three dimensions to be determined.

Any of the known sound sensing devices can be used herein. Preferably, the sound sensing devices are of the stationary type. More preferably, rotating or vibrating sound sensing devices (movable) may be used in place of stationary sound sensing devices. This allows for a lesser number of sensors, while still providing the increased accuracy that results from using a larger number of stationary sound sensing devices.

In this manner, the relative position of every sound source 1 in a given environment may be determined. In a preferred embodiment, the sound source 1 that is closest to the wireless telephone 100 is identified as the desired sound source since it is the voice of the user of the wireless telephone 100. Thereafter, the controller 14 provides for filtering out all sound signals other than that representing the desired sound source. The user of the telephone 100 can be identified in this manner to a high degree of certainty since they will be the closest sound source to the wireless telephone 100 and will also be positioned at a unique position relative to all other sound sources. That is, the user will be positioned essentially right in front of the sound sensing device 12a, 12b. This allows the user to be easily identified as the desired sound source and the sound signal corresponding to their voice isolated as the desired sound signal.

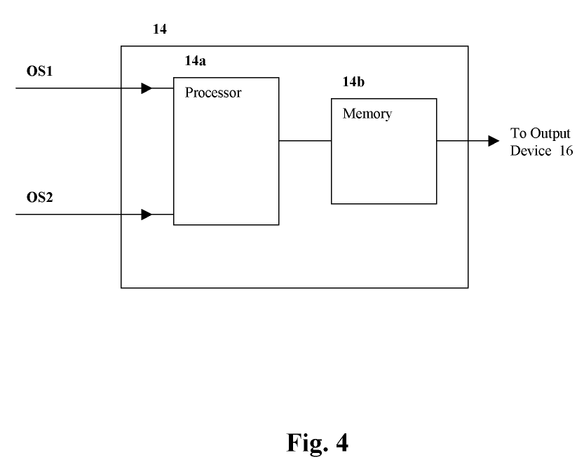

FIG. 4 illustrates an exemplary embodiment of the controller 14. While the controller 14 is illustrated as a part of the audio filter 10, the controller 14 may be embodied as the processor, or controller, that controls operation of the wireless telephone 100, for example, in FIG. 3. In this case, software may be used to provide instructions for filtering as described above. The controller 14 preferably includes at least one processor 14a that receives the output signals OS1, OS2, from the devices 12a, 12b and determines the relative position of each of the sound sources in the environment based on the phase shift between the output signals OS1, OS2. Based on this information, the processor 14a further identifies the closest sound source and filters out all sound signals other than the desired sound signal from the closest sound source. One, non-limiting example of such filtering is described in more detail below.

A memory 14b is preferably provided and the filtered desired sound signal may be stored therein. From the memory, the desired sound signal may be read out and provided to the output device 16, if desired, for transmission to another wireless telephone, for example. This desired sound signal is completely clear of any background noises, and thus, will sound very clear to a remote caller when it is transmitted via the output device 16.

The desired sound signal is preferably stored for an extended period of time. In this manner, the processor 14a can quickly identify the desired sound signal in the future without necessarily requiring a determination of which sound source is closest to the telephone 100. If desired the memory 14b may be a separate memory device independent of the controller 14, as well.

More specifically, in a preferred embodiment, the controller 14 will learn the unique frequency signature of the desired sound signal based on the stored desired sound signal in the memory 14b. This will allow the processor 14a, for example, to continually separate the desired sound signal from other sounds represented in the signals OS1, OS2 from the devices 12a and 12b, even if the position of the desired sound source (the caller in this case) changes. That is, the audio filter 10 allows for the continued filtering of all sounds other than the desired sound signal even if the position of the source associated therewith changes such that it is no longer the closest to the sensor devices 12a, 12b.

Indeed, in a preferred embodiment, as is noted above, the controller 14 (or processor) may be used to immediately isolate such a learned desired sound signal, even if the desired sound signal is not the closest sound signal at the beginning of a call, for example. In another embodiment, the unique frequency signature of the desired sound signal may be pre-loaded into the controller 14 to allow for the immediate isolation of the desired sound signal regardless of its position. That is, the desired sound signal may be pre-loaded into the memory 14b.

The audio filter 10 of the present disclosure thus allows for the easy recognition and isolation of a user's voice based on position relative to the wireless telephone 100 and then tracks this voice to ensure that it remains isolated even if the user moves relative to the telephone 100.

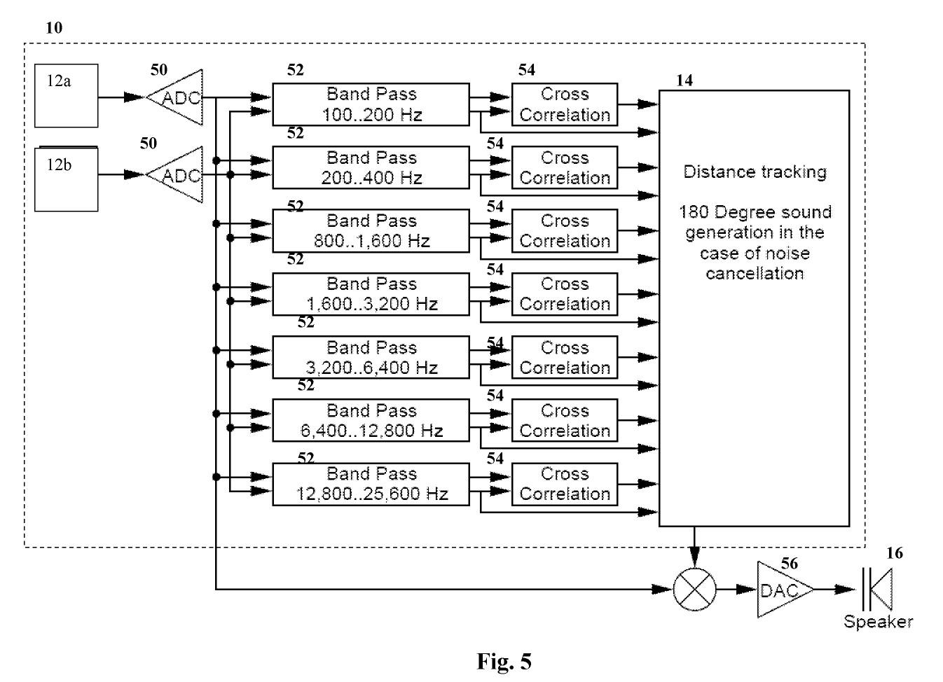

In another embodiment, the audio filter 10 may also be used to filter sound information received from another telephone, for example from the transmitter-receiver. In this case, the desired sound signal, which may be a second desired sound signal, is preferably pre-stored in the controller 14. The controller 14 will then filter out any other sounds in the incoming sound information that do not correspond to this desired sound signal. In this case, the controller 14 is preferably also connected to a speaker (See FIG. 5, for example) that will allow the user to hear the filtered desired sound signal.

While the audio filter 10 has been described generally for use in telephones, and particularly a wireless telephone 100, it is not limited to use in a telephone. For example, the audio filter 10 may be used in a listening device and utilized to isolate specific voices in a room or building, if desired, based on their relative position. Thereafter, the filter may continue to isolate this voice even as its position changes. In this embodiment, the output device 16 may be a wireless transmitter-receiver that may broadcast to a remote location, or may be a simple recording device that records the desired sound signal. Further, information regarding the position of each of the sound sources in the room may be isolated and recorded if desired to allow for later review of another sound source, if desired. Indeed, multiple audio filters in accordance with the present application may be provided to isolate several different sound signals from several different sound sources such that all conversations in a corded room, for example, may be monitored or recorded.

FIG. 5 is an exemplary schematic representation of an audio filter 10 in accordance with the present disclosure. As illustrated, the sound sensing devices 12a, 12b are preferably connected to analog to digital converters (ADC) 50. In a preferred embodiment, 12 bit per uS converters are used, however, any suitable converter may be used. As is noted above, additional sound sensing devices may be used if desired. The digital signal output from the converters 50 is a digital representation of the sounds picked up by the sensing devices 12a, 12b, respectively. The output of the converters 50 is provided to each of a plurality of band pass filters 52. Each filter 52 filters out all elements of the sound signals other than those in a specific frequency band. Thus, the sound signals are separated into distinct frequency bands.

The output of each filter 52 represents the sound information specific to the allowed frequency band picked up by each of the sensing devices 12a, 12b respectively. This information is provided to the cross correlation devices 54 which calculates the time delay, and the amplitude difference between the sound received at the sensor 12b and the sound received at the sensor 12a. Based on these differences, and the non-correlated band pass output related to the second sensor 12b, the controller 14 generates an inverted signal that can be used to strip out all sound elements except for the desired signal. The desired signal is typically that of the source closest to the filter, as noted above, and the information regarding the time delay and amplitude delay may be used to determine the distance of each source from the filter 10. More specifically, the information may be used to determine the time of travel of sounds from each sound source to the sensing devices 12a, 12b. The speed of sound is known as well as the distance between the sensors 12a, 12b. The distance between sensors 12a, 12b in FIG. 5 is 30 mm, but may be set at any desired distance. The speed of sound is 340 meters per second which means it takes 2.94 uS for sound to travel 1 mm. Thus, the delay between reception at the devices 12a and 12b and the attenuation of the amplitude, can be used to determine the relative distance of each sound source S1, S2, S3 from each of the sensors 12a, 12b. Thus, the position of each sound source S1, S2, S3 can be calculated and this signal identified as the desired signal.

This information is then used to provide a filtering signal that is combined with the unfiltered audio signal provided from the converters 50 to provide a clean and background noise free signal. In particular, the filtering signal provided from the controller 14 is a phase inverted signal that is mixed with the unfiltered signal provided by the converters 50 to strip out undesired sound elements by destructive interference. Thus, the only remaining sound element is the desired signal.

This signal is converted to analog form by the digital to analog (DAC) converter 56. This analog signal is then preferably provided to the output device 16, illustrated in FIG., 5 as a speaker. The output device 16 need not be a speaker, and in which case it may not be necessary to convert the signal into analog form. In this case, there may be no need for the converter 56.

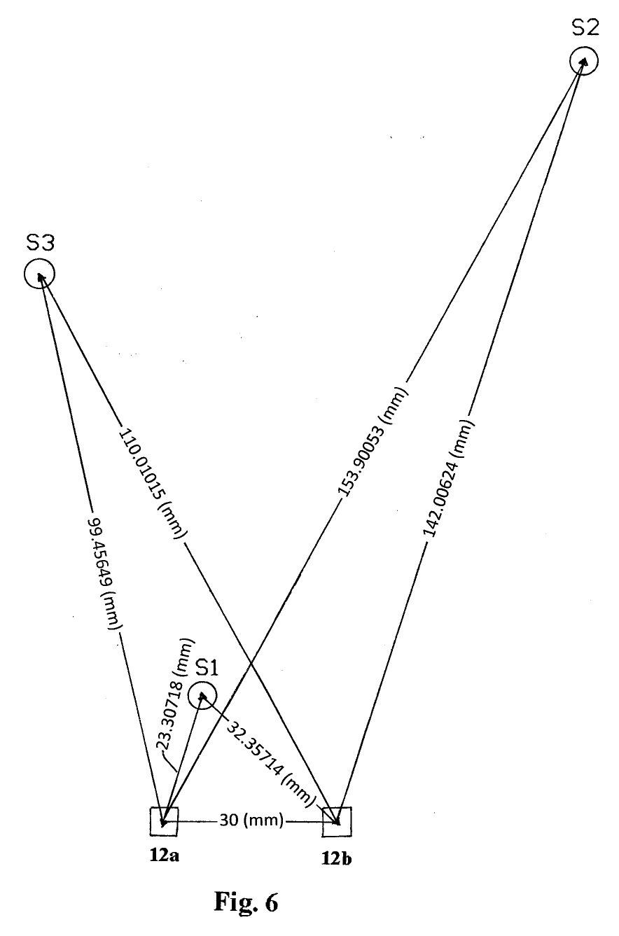

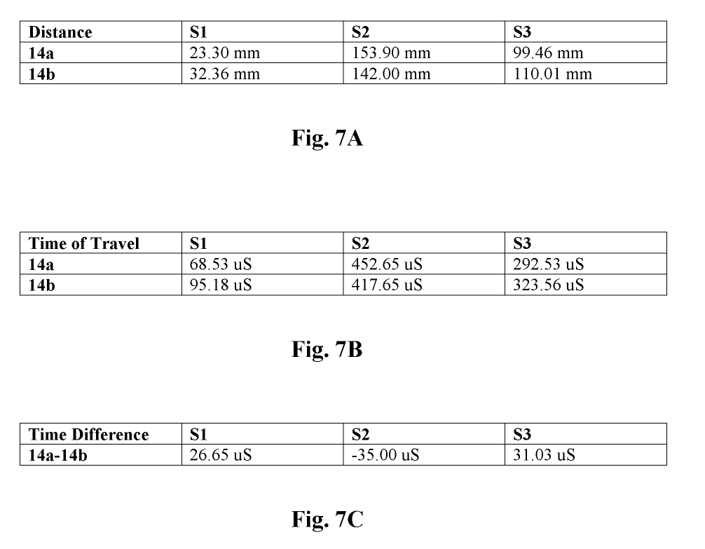

FIG. 6 is a drawing illustrating the relative positions of three sound sources S1, S2, S3 relative to the sound sensing devices 12a, 12b of FIG. 5. FIGS. 7A-7C illustrate the calculated distances, time of travel and phase delay using the filter 10 of FIG. 5.

While an exemplary embodiment of the filter 10 is described with reference to FIGS. 5-7, it is noted that the filter of the present disclosure is not limited to this example and may be implemented in any suitable manner.

Although the present invention has been described in relation to particular embodiments thereof, many other variations and modifications and other uses will become apparent to those skilled in the art.

WHAT IS CLAIMED IS:

1. An audio filter comprising:
a sound sensor operable to detect sound and to provide a sensor signal representative of sound detected by the sound sensor; and
a controller operable to process the sensor signal to provide a desired sound signal representative of sound from a desired sound source,
wherein the desired sound source is identified by a position of the desired sound source relative to the audio filter, and
wherein the controller filters the sensor signal to isolate the desired sound signal even after the desired sound source has changed position.

2. The audio filter of claim 1, wherein the sound sensor further comprises at least two sound sensing devices:
a first sound sensing device operable to provide a first electronic output signal; and
a second sound sensing device operable to provide a second electronic output signal,
wherein the first and second sound sensing devices are positioned a predetermined distance from each other, and
wherein the sensor signal includes the first and second electronic output signals.

3. The audio filter device of claim 2, wherein the controller identifies a respective position of each of a plurality of sound sources based on a phase difference detected between the first electronic output signal and the second electronic output signal.

4. The audio filter device of claim 3, wherein the desired sound source is a sound source positioned closest to the audio filter.

5. The audio filter device of claim 4, wherein the controller further comprises a memory device operable to record the desired sound signal.

6. The audio filter device of claim 5, further comprising a transmitter operable to wirelessly transmit the desired sound signal, wherein the transmitter receives the desired sound signal from the memory device.

7. The audio filter of claim 2, wherein the first and second sound sensing devices are stationary.

8. The audio filter of claim 2, wherein at least one of the first and second sound sensing devices is movable.

9. The audio filter of claim 3, further comprising at least a third sound sensing device operable to provide at least a third electronic output signal, wherein the controller identifies a more exact position of each of a plurality of sound sources based on phase differences detected between the first electronic output signal, the second electronic output signal and the third electronic output signal.

10. The audio filter of claim 3, further comprising at least a fourth sound sensing device operable to provide at least a fourth electronic output signal, wherein the controller identifies a unique position in three dimensional space of each of a plurality of sound sources based on phase differences detected between the first electronic output signal, the second electronic output signal, the third electronic output signal and the fourth electronic output signal.

11. The audio filter of claim 1, wherein the audio filter is utilized in a wireless telephone.

12. The audio filter of claim 1, where the audio filter is utilized in a cellular telephone.

13. The audio filter of claim 1, wherein the audio filter is utilized in a surveillance device.

14. A wireless telephone comprising:
a sound sensor operable to detect sound and to provide a sensor signal representative of sound detected by the sound sensor;
a controller operable to process the sensor signal to provide a desired sound signal representative of sound from a desired sound source,
wherein the desired sound source is identified by a position of the desired sound source relative to the wireless telephone and the controller filters the sensor signal to isolate the desired sound signal even after the desired sound source has changed position; and
an input/output device operable to wirelessly transmit the desired sound signal to another wireless telephone.

15. The wireless telephone of claim 14, wherein the sound sensor further comprises at least two sound sensing devices:
a first sound sensing device operable to provide a first electronic output signal; and
a second sound sensing device operable to provide a second electronic output signal,
wherein the first and second sound sensing devices are positioned a predetermined distance from each other, and
wherein the sensor signal includes the first and second electronic output signals.

16. The wireless telephone of claim 15, wherein the controller identifies a respective position of each of a plurality of sound sources based on a phase difference detected between the first electronic output signal and the second electronic output signal.

17. The wireless telephone of claim 16, wherein the desired sound source is a sound source positioned closest to the wireless telephone.

18. The wireless telephone of claim 17, wherein the controller further comprises a memory device operable to record the desired sound signal.

19. The wireless telephone of claim 18, further comprising an input/output device that includes a transmitter operable to wirelessly transmit the desired sound signal to a second wireless telephone, wherein the transmitter receives the desired sound signal from the memory device.

20. The wireless telephone of claim 19, wherein the input/output device further comprises a receiver operable to receive information from the second wireless telephone, wherein received information is provided to the controller and filtered to isolate a second desired sound signal.

21. The wireless telephone of claim 20, further comprising a speaker operable to reproduce sound based on the second desired sound signal.

22. The wireless telephone of claim 15, wherein the first and second sound sensing device are stationary.

23. The wireless telephone of claim 15, wherein at least one of the first and second sound sensing devices are movable.

24. The wireless telephone of claim 16, further comprising at least a third sound sensing device operable to provide a third electronic output signal, wherein the controller identifies a more exact position of each of a plurality of sound sources based on phase differences detected between the first electronic output signal, the second electronic output signal and the third electronic output signal.

25. The wireless telephone of claim 16, further comprising at least a fourth sound sensing device operable to provide a fourth electronic output signal, wherein the controller identifies a unique position in three dimensional space for each of a plurality of sound sources based on phase differences detected between the first electronic output signal, the second electronic output signal, the third electronic output signal and the fourth electronic output signal.

26. The wireless telephone of claim 14, wherein the wireless telephone is a cellular telephone.
